(19) United States
(12) Patent Application Publication
(10) Pub. No.: US 2019/0104815 A1
(43) Pub. Date: Apr. 11, 2019

(54) TRANSIT PACKAGING

(71) Applicant: EURO PACKAGING UK LTD., Birmingham (GB)

(72) Inventors: Zarak Lowe, Bloxwich (GB); Padraic O'Hara, Redditch (GB); Jack Knight-Adams, Upper Colwall (GB)

(73) Assignee: EURO PACKAGING UK LTD., Birmingham (GB)

(21) Appl. No.: 15/725,526

(22) Filed: Oct. 5, 2017

(51) Int. Cl. A45C 3/04; A45C 3/00; B65D 33/16; B65D 33/10; B31B 70/86

(52) U.S. Cl. CPC A45C 3/04; A45C 3/001; A45C 13/03; B65D 33/105; B31B 70/864; B65D 33/1691

(57) ABSTRACT

The invention provides a container for use in the transportation of one or more consumer goods wherein the container is sealable and wherein the container comprises one or more internal handles such that the container is suitable for use as a carrier bag when in an unsealed configuration.

The present invention relates to an improved flexible container primarily for the use in delivery and collection applications.

On-line/mail order shopping is a growing retail trend as consumers strive towards convenience. An alternative method to home delivery is ‘Click & Collect’ whereby the customer places an order on-line and then collects in-store/on-site for their added convenience. Currently there are multiple packaging solutions that are utilised for this application, but none which offer significant added value (to both the customer and retailer). In addition, the majority of flexible delivery containers are manufactured from a plastic derived film which portrays negative environmental perceptions.

A way of enhancing the experience for both retailer and customer has been sought.

According to the invention, there is provided a container for use in the transportation of one or more consumer goods wherein the container is sealable and wherein the container comprises one or more internal handles such that the container is suitable for use as a carrier bag when in an unsealed configuration.

Advantages of the invention include that the container can be transformed from a sealed pack to a fully functioning, reusable shopping bag; the container can be opened at point of collection with no damage to the container or its contents such that its contents can be checked and then it can be used to conveniently carry its contents away from the point of collection without a further bag being needed.

In some embodiments, the container may be a flexible container comprising a minimum of 2 vertical walls, an enclosed base and an open cavity. The container is formed by the two walls being joined along their vertical edges, possibly via a seal or creased edge, and along their horizontal edges opposite to the open cavity. The invention relates to unique method of sealing, opening and carrying the flexible container in the intended application of ‘Click and Collect”.

In some embodiments, the container may be formed from at least two walls. In some embodiments, the flexible container may be formed with an integral folded base which expands between the walls to provide additional depth and fill capacity to the container. This feature is commonly referred to as a bottom gusset. In some embodiments, the flexible container may have a side wall arranged between the walls on one or both sides of the container.

In some embodiments, the container might typically be in the form of a bag.

In some embodiments, the container may have a flap to seal the container. In some embodiments, one of the vertical walls of the flexible container may extend vertically above the open cavity edge of its opposite wall to form the flap. In some embodiments, the flap may incorporate an adhesive strip which preferably runs horizontally across the length of the flap from edge to edge. In some embodiments, the adhesive strip may have a removable liner strip to protect the adhesive.

In some embodiments, in operation, when the container has been packed with one or more products, the flap may be arranged to fold horizontally, enclosing the open cavity in doing so. During this operation, the adhesive strip located on the internal face of the pre-described flap meets the external face of the opposite wall of the flexible container, thus creating a completely sealed container. In this assembled format, the container becomes secure for delivery/transit to site, store or distribution centre (DC).

In some embodiments, one or both of the walls of the container incorporate tear lines to form a removable upper portion for opening a sealed container. For example, both walls may comprise a single horizontal pre-determined tear line which runs from edge to edge of the said container. Typically, these pre-determined tear lines will comprise a series of cuts; more commonly referred to as perforations (or perforation lines). Each perforation line is aligned such that dimensionally, from the bottom edge of the container (the edge opposite the open cavity of the container), each measures substantially or exactly the same distance.

In some embodiments, the horizontal perforation lines are located below where in use the flap attaches to the self-adhesive strip.

In some embodiments, there may be provided a means to efficiently and effectively open the sealed container to allow the customer to inspect their goods at point of collection. This is achieved by the removal of the upper portion of the sealed flexible container via the hand operational engagement of the pre-described perforation lines. This manual ‘tear-off’ action effectively removes the pre-determined upper portion or section of both vertical walls of the sealed flexible container (including the sealed flap), thus revealing the open cavity in the flexible container and transforming the sealed package into an open bag-like format.

In some embodiments, there may be provided a handle, or handles, to allow the flexible container to be carried once the sealed container has been opened. Each handle may be adhered to the internal face of the pre-described vertical walls of the flexible container. Each handle is typically created via a ‘U-Shape’ piece of material which has been formed to create a loop-like, carrying profile.

In some embodiments, the handle bond to the container walls may be reinforced by a secondary piece of material, often referred to as a ‘patch’.

In some embodiments, each handle may be aligned and positioned in the flexible container as such that once the pre-described upper portion of the flexible container has been removed, and the said sealed container has been transformed into a container with an open cavity, the loop profile of each handle protrudes above the vertical walls (and subsequent cavity opening) allowing the container to be carried away from its collection point and further re-used as a bag if and when required.

In some embodiments, the handle may be formed from single ply material, multiple ply material or a twisted or braided material format.

In some embodiments, the handle loop profile may not automatically protrude above the top edge of the open container but may require a manual operation to select each handle. Once these handles have been selected, however, the functionality of the invention remains consistent.

In some embodiments, the container may be formed from a substrate which comprises: paper, polyethylene, polypropylene, starch based films, polyvinyl alcohol, paper laminate structures, polymer laminate structures.

In some embodiments, the container may form an aperture to allow it to be hung from a hook before or after it has been filled. In some embodiments, the container may have an extending portion in which the aperture is formed. In some embodiments, the aperture may be formed in the flap such that a handle may extend through the flap such that the container may be hung from the handle even when the container is sealed.

In some embodiments, the container may be suitable for packaging medical items (for example creams and ointments), apparel (for example shoes, shirts, t-shirts, jumpers and trousers), luxury items (for example watches or jewelry), cosmetics (for example make-up or toiletries), electronics (for example mobile telephones, cameras, headphones), home-wares (for example soft furnishings) and/or food items (for example pre-packed biscuits, confectionery or chocolates).

The invention will now be illustrated with reference to the following Figures of the accompanying drawings which are not intended to limit the scope of the claimed invention:

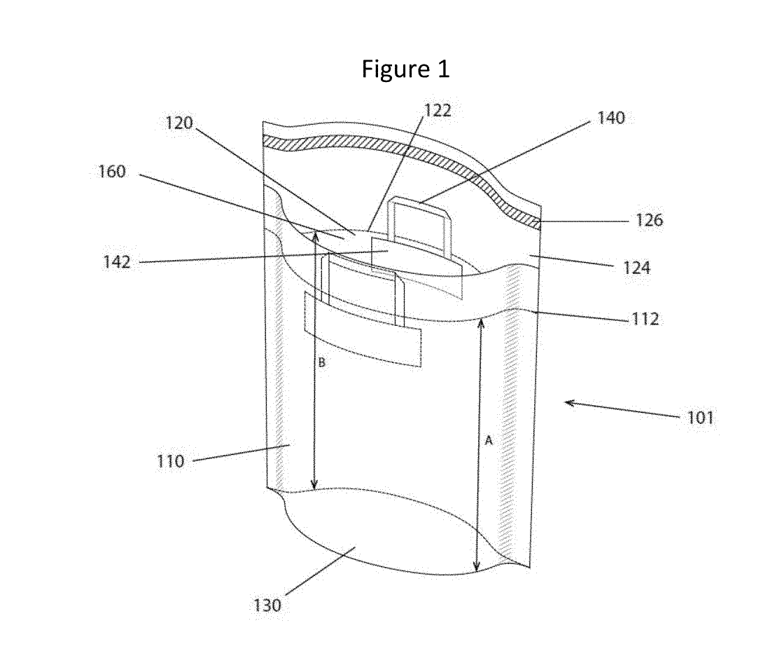

FIG. 1 shows a schematic perspective of a flexible container according to the invention in an open position such that the container is in an unsealed configuration;

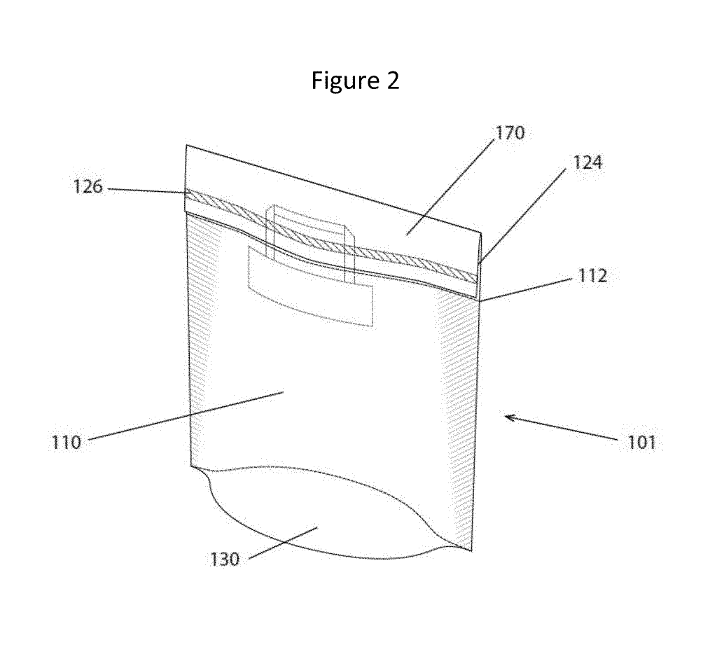

FIG. 2 shows a schematic perspective of a flexible container according to the invention in a closed/sealed position or configuration;

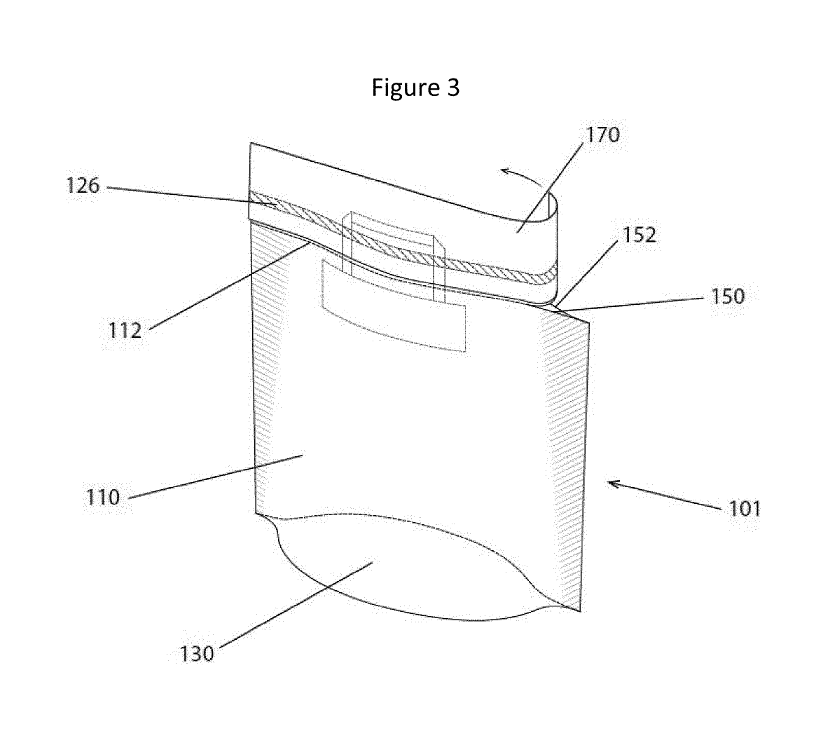

FIG. 3 shows a schematic perspective of a sealed flexible container according to the invention in a first half transformation position;

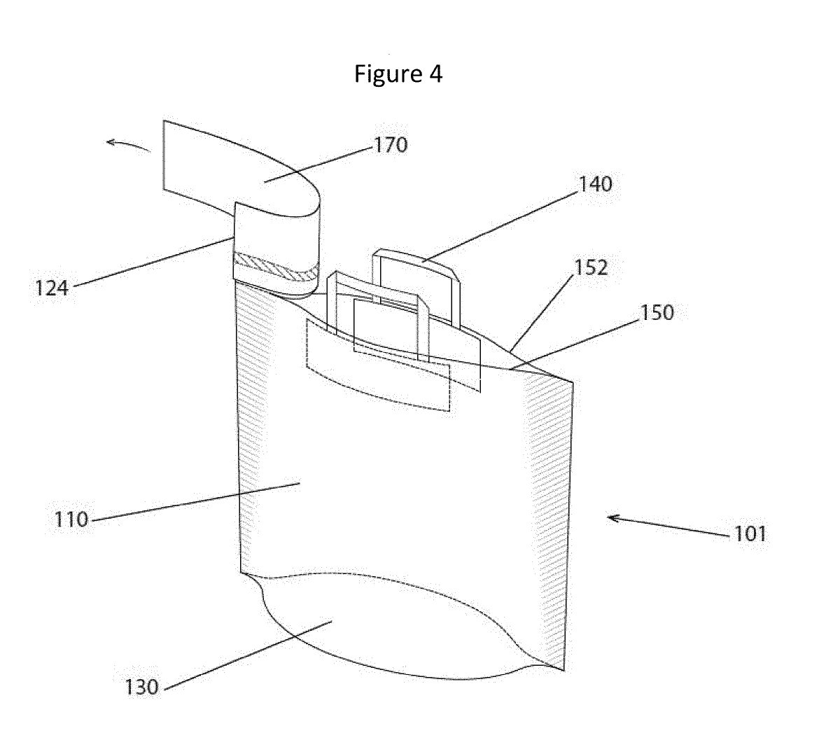

FIG. 4 shows a schematic perspective of a flexible container according to the invention in a second half transformation position;

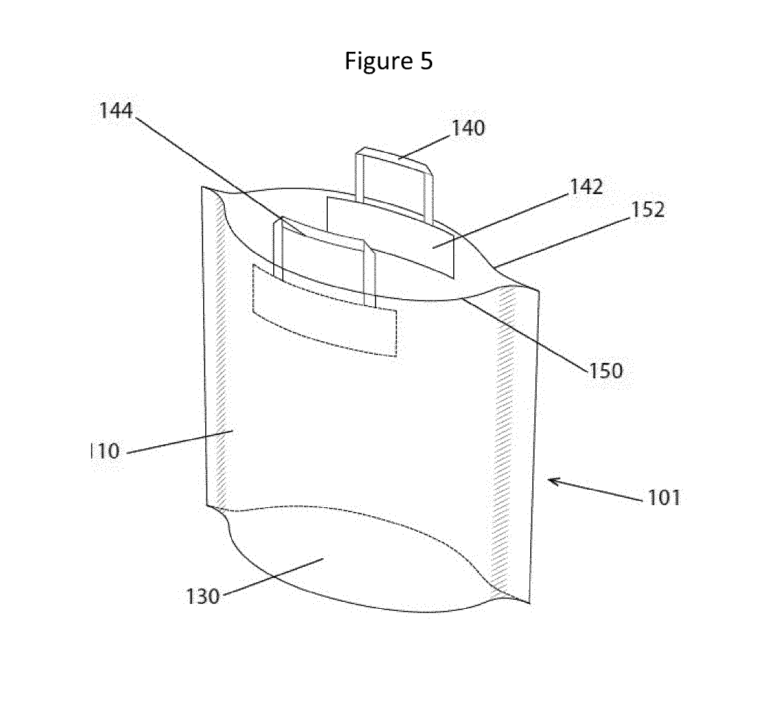

FIG. 5 shows a schematic perspective of a flexible container according to the invention in the fully transformed position; i.e the upper portion has been fully removed;

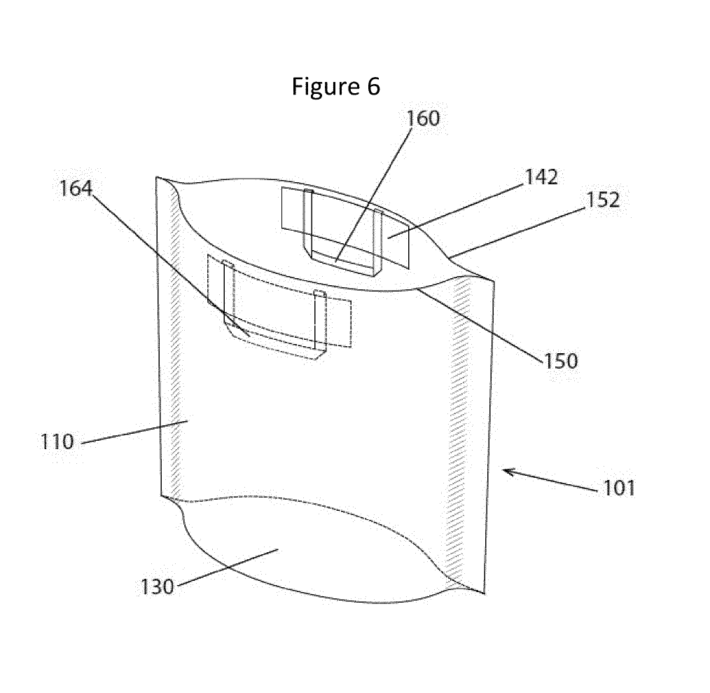

FIG. 6 shows a schematic perspective of a flexible container according to a second, alternative embodiment of the invention in the fully transformed position; i.e the upper portion has been fully removed;

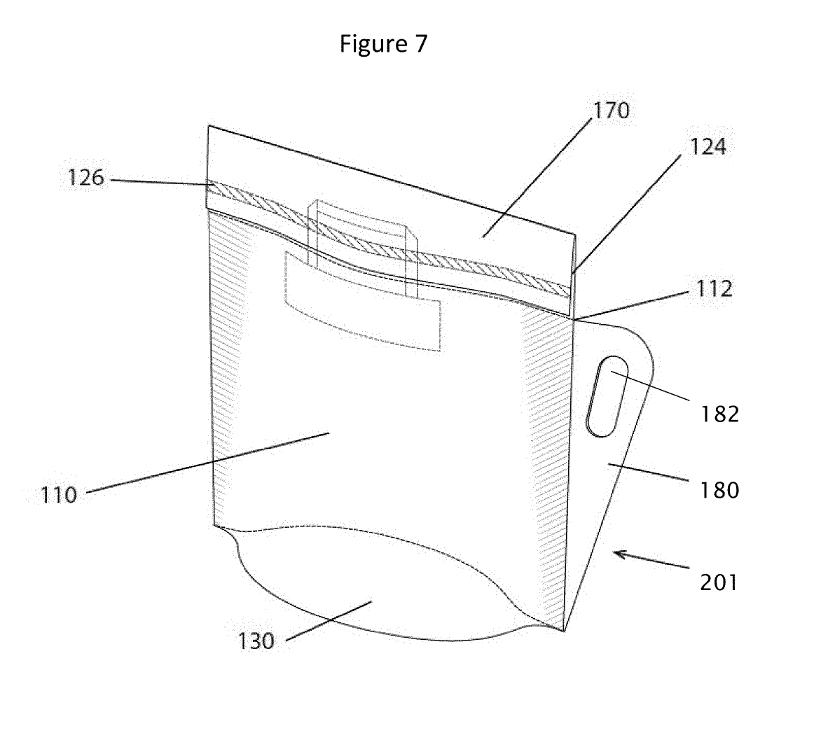

FIG. 7 shows a schematic perspective view of a sealed flexible container according to a third embodiment of the invention;

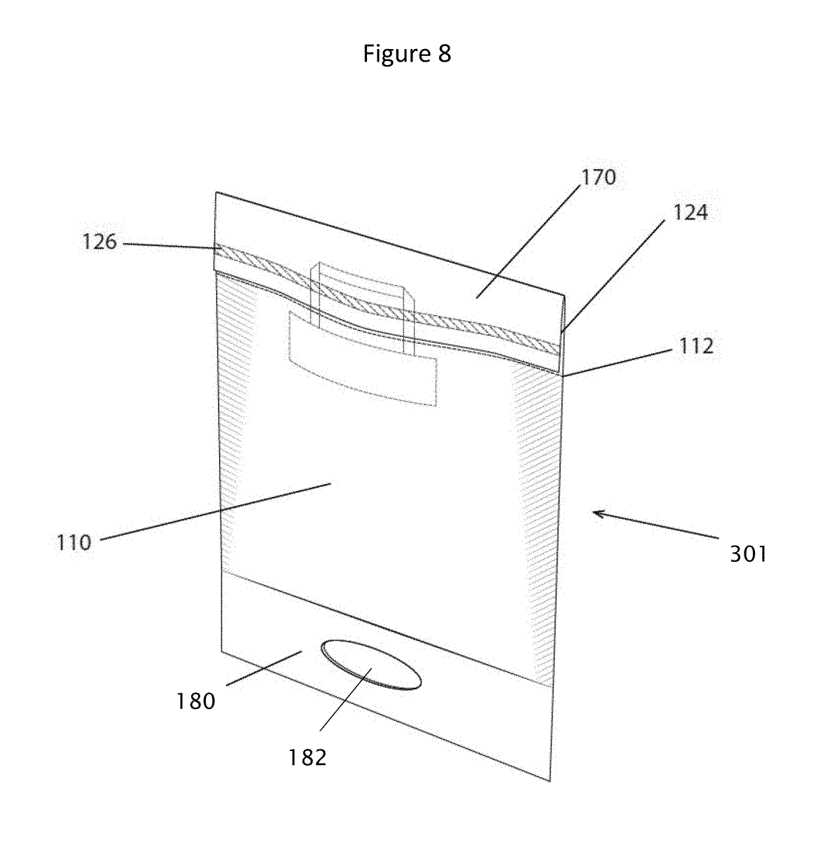

FIG. 8 shows a schematic perspective view of a sealed flexible container according to a fourth embodiment of the invention;

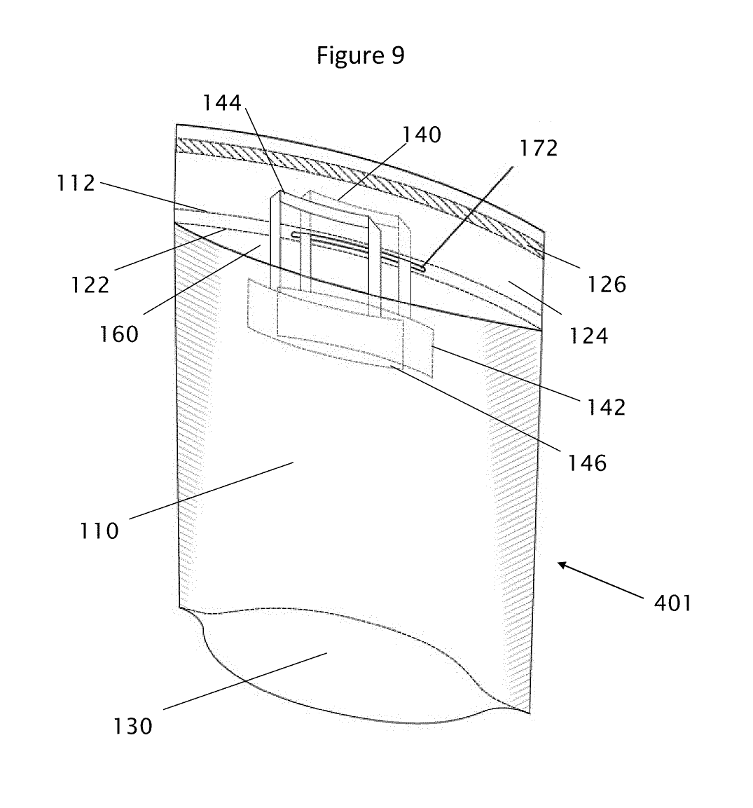

FIG. 9 shows a schematic perspective view of a flexible container according to a fifth embodiment of the invention; and

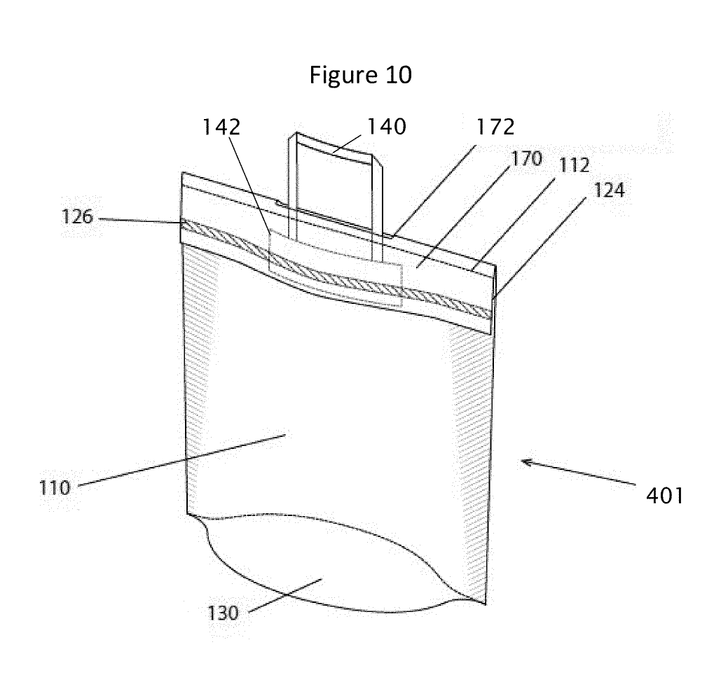

FIG. 10 shows a schematic perspective view of a sealed flexible container according to the fifth embodiment of the invention.

A container according to a first embodiment the invention is indicated generally at 101 on FIGS. 1, 2, 3, 4, and 5.

Flexible container 101 is a bag-like structure with a front wall 110, a rear wall 120, a base 130 and open cavity 160. Rear wall 120 extends above cavity 160 to form a lip indicated at 124. Lip 124 has an adhesive strip running horizontally from edge to edge at 126. Walls 110,120 are joined at their sides to form the container 101.

Horizontal lines of perforation 112,122 are formed in walls 110,120 such that a removable upper portion 170 is formed by the parts of the walls 110,120 above the perforation lines 112,122. The perforations according to the invention are shown at 112 and 122. Perforation 112 is incorporated into wall 110 and perforation 122 is incorporated into wall 120. The perforation locations in relation to base 130 are shown by lengths A and B. It is preferable that A and B are equal.

The handles according to the first embodiment of the invention are indicated at 140, and the potential reinforced patch at 142. Handles 140 are mounted by patches 142 at the upper end of cavity 160 on each of walls 110,120. In an alternative embodiment, the patches 142 may be omitted for example if the handles 140 and the walls 110,120 are formed from plastic as each handle 140 may be welded on to its respective wall 110,120. In an alternative embodiment, a single handle 140 may be used which may be mounted at each side of the upper end of cavity 160 where the walls 110,120 join.

The pre-determined upper portion for removal from the container is shown at 170. During the removal of upper portion 170, perforation 112 creates edge 150 and perforation 122 creates edge 152.

A container 101 according the first embodiment of the invention has handles at 140 and 144, whereby both protrude above edges 150 and 152.

A container according to the second or alternative embodiment of the invention is indicated generally at 101 on FIG. 6. Like features to the features of the first and second embodiments are identified by like reference numerals. In the second alternative embodiment of the invention shown in FIG. 6, handles which do not protrude above edges 150 and 152 are shown at 160 and 164. In an alternative embodiment, the patches 142 may be omitted for example if the handles 140 and the walls 110,120 are formed from plastic as each handle 140 may be welded on to its respective wall 110,120. In an alternative embodiment, a single handle 140 may be used which may be mounted at each side of the upper end of cavity 160 where the walls 110,120 join.

A container according to the third embodiment is indicated generally at 201 on FIG. 7. Like features to the features of the first and second embodiments are identified by like reference numerals. Container 201 has an extending portion 180 which is attached to one side of container 201 and which forms an extension aperture 182 which is shaped to allow the container 201 to be hung. In an alternative embodiment, the patches 142 may be omitted for example if the handles 140 and the walls 110,120 are formed from plastic as each handle 140 may be welded on to its respective wall 110,120. In an alternative embodiment, a single handle 140 may be used which may be mounted at each side of the upper end of cavity 160 where the walls 110,120 join.

A container according to the fourth embodiment is indicated generally at 301 on FIG. 8. Like features to the features of the first, second and third embodiments are identified by like reference numerals. Container 301 has an extending portion 180 which is attached to the base 130 of container 301 and which forms an extension aperture 182 which is shaped to allow the container 301 to be hung upside down. In an alternative embodiment, the patches 142 may be omitted for example if the handles 140 and the walls 110,120 are formed from plastic as each handle 140 may be welded on to its respective wall 110,120. In an alternative embodiment, a single handle 140 may be used which may be mounted at each side of the upper end of cavity 160 where the walls 110,120 join.

A container according to the fifth embodiment is indicated generally at 401 on FIGS. 9 and 10. Like features to the features of the first, second, third and fourth embodiments are identified by like reference numerals. Container 401 has a first handle 140 attached at patch 142 to wall 120 and a second handle 144 attached at patch 146 to wall 110. Flap 124 of container 401 forms a flap aperture 172 through which handle 140 is arranged to extend. The handle 140 may therefore be used to suspend the container 401. The perforation lines 112,122 of container 401 are formed to either side of flap aperture 172 such that the removable upper portion 170 includes flap aperture 172. In an alternative embodiment, container 401 may have two handles 140,144. In an alternative embodiment, the patches 142 may be omitted for example if the handles 140 and the walls 110,120 are formed from plastic as each handle 140 may be welded on to its respective wall 110,120. In an alternative embodiment, a single handle 140 may be used which may be mounted at each side of the upper end of cavity 160 where the walls 110,120 join.

1. A container for use in the transportation of one or more consumer goods wherein the container is sealable and wherein the container comprises one or more internal handles such that the container is suitable for use as a carrier bag when in an unsealed configuration.

2. A container as defined in claim 1 which is a flexible container comprising a minimum of two vertical walls, an enclosed base and an open cavity.

3. A container as defined in claim 2 which is formed with an expandable folded base to provide additional depth and fill capacity to the container.

4. A container as defined in claim 2 which is formed from at least two walls.

5. A container as defined in claim 1 which has a flap to seal the container.

6. A container as defined in claim 5 which is formed from at least two walls wherein at least one of the walls extends to form the flap.

7. A container as defined in claim 5 wherein the flap incorporates an adhesive strip for sealing the container.

8. A container as defined in claim 1 wherein the one or more handles are adhered to an internal surface of the container.

9. A container as defined in claim 1 which has an aperture suitable for use in suspending the container.

10. A container as defined in claim 9 wherein the container has an extending portion in which the aperture is formed.

11. A container as defined in claim 9 wherein the aperture is formed in the flap such that a handle may be arranged to extend through the flap.

12. A container as defined in claim 1 which has a removable upper portion for opening the container.

13. A container as defined in claim 12 wherein the removable upper portion is defined by a tear line.

14. A container as defined in claim 13 which comprises at least two walls and wherein the tear line is provided on the walls.

15. A container for use in the transportation of one or more consumer goods wherein the container is sealable and comprises at least two walls, wherein the container comprises one or more internal handles such that the container is suitable for use as a carrier bag when in an unsealed configuration and wherein the container has a removable upper portion for opening the container wherein the removable upper portion is defined by a tear line which is provided on the walls.

16. A container for use in the transportation of one or more consumer goods wherein the container is sealable, wherein the container comprises one or more internal handles such that the container is suitable for use as a carrier bag when in an unsealed configuration, and wherein the container has an aperture suitable for use in suspending the container.
